(19) United States
(12) Patent Application Publication
(10) Pub. No.: US 2007/0275859 A1
(43) Pub. Date: Nov. 29, 2007

(54) Method for Manufacturing Accelerator having Chitosan and Chlorophyll

(76) Inventor: Hsien-Chih Lin, Taichung (TW)

Correspondence Address: HDSL, 4331 STEVENS BATTLE LANE, FAIRFAX, VA, 22033, US

(21) Appl. No.: 11/419,842

(22) Filed: May 23, 2006

(51) Int. Cl. A01N 25/00

(52) U.S. Cl. 504/358

(57) ABSTRACT

A plant growth mediator hainb chitosan and chlorophyll generating accelerator and the method for manufacturing the same. A simple method is used to make chitin dissolve into and stored in the acid water to obtain chitosan having granulars, and, after the plant growth mediator having chlorophyll generating accelerator is added, then the plant growth mediator having chitosan and chlorophyll generating accelerator of present invention is obtained.

### BACKGROUND OF THE INVENTION

1. Field of the Invention

The present invention relates to a plant growth mediator having chitosan and chlorophyll generating accelerator and the method for manufacturing the same. More particularly, it relates to a method of forming water-soluble chitosan with granular particles from chitin and then to form plant growth mediator having chitosan and chlorophyll generating accelerator, and the method for manufacturing the same.

2. Background of the Invention

It is known to public that, the plants have chlorophylls and enzymes, the chlorophyll can absorb solar energy, that is, absorb blue, red lights and reflect green lights, such that the plants are green. After the solar energy is absorbed, by the assistance of enzyme, carbon dioxide and the water absorbed from root are chemically reacted to form glucose for plant's absorption and growth. It is then can be understood that, if there is no chlorophyll, then the plants can not grow. The main elements to form chlorophyll are iron (Fe), calcium (Ca), phosphine (P), Magnesium (Mg), while the catalysts of oxidization and reduction for forming chlorophyll are Magnesium (Mg), Iron (Fe), Manganess (Mn), and zinc (Zn). Due to the above mentioned elements can act as reduction enzymes during the process of growing chlorophyll, they are then helpful for growing chlorophyll. The above elements are generally used as the forms of chemicals of “oxalates”, “sulfates” or “acetates”. However, the elements and chemicals are difficult to be dissolved in water, and then it can not be formed into solutions for absorptions of plants' leaves and to accelerate the growth of chlorophyll.

Chitin is found in the exoskeletons of crustaceans, insect cuticles, organs of the mollusks, and fungal cell walls. The difference between chitin and chitosan is the degree of the deacetylation. Chitin is highly acetylated glucosamine. General speaking, chitin itself is not soluble in the water. Therefore, it requires a soluble medium for forming the water-soluble chitosan. In other words, the distinction between chitin and chitosan is based on the solubility in the dilute acid solution (for example, 2% acetic acid). That is in the mixture of chitin and chitosan under acetic acid, the soluble part is chitosan, and the insoluble part is chitin. FIG. 1 shows the structures of chitin and chitosan. In general, chitin is extracted from crustacean shell and it contains 15% of amine and 85% of acetyl group. When the deacetylation degree is over 70%, it can transform into the water-soluble chitosan which can be dissolved in the dilute acid solution. In other words, chitin having 70% and/or more of amine is called chitosan.

The water-soluble chitosan is commonly produced by the following process. First, the organic acid is added into the water-swollen chitin for dissolution. Therefore, chitin in a swollen state can be dissolved in the acid solution. However, the above process only adds chitin in the acid solution for forming a gel from the surface of chitin, while it is not completely dissolved into the water. Also, it requires other complicated process to complete, such as alkali thermal hardening method, and enzyme method.

According to the above prior art, even the chitin structure is adjusted, it is not easy for chitin to keep a liquid state during transmission. Furthermore, when chitin is preserved in a liquid state for a period, it is easy to cause deterioration. For example, the color becomes brown, and the liquid becomes turbid. Further, when the concentration of the liquid chitin is higher, it can cause a solid crystal form.

Consequently, it is not suitable to apply conventional chitosans at plant, and it is then a loss to people.

### SUMMARY OF THE INVENTION

The present invention is to provide a plant growth mediator having chitosan and chlorophyll generating accelerator and the method for manufacturing the plant growth mediator. By a simple manufacture method as mentioned in the present invention, chitosan can be dissolved into and stored in the acid water to obtain plant growth mediator having chitosan and chlorophyll generating accelerator and the granular particles of chitosan is produced to have excellent preservative and stable properties.

Additional features and advantages of the invention will be set forth in the detailed description which follows, and in part will be readily apparent to those skilled in the art from the description or recognized by practicing the invention as described in the written description and claims hereof, as well as the appended drawings.

### BRIEF DESCRIPTION OF THE DRAWINGS

FIG. 1 shows the structures of chitin and chitosan;

FIG. 2 shows a structure formula of the polymer water-soluble chitosan;

FIG. 3 is a flow chart showing one example for manufacturing chitosan in the plant growth mediator having chitosan and chlorophyll generating accelerator of the present invention;

FIG. 4 is a flow chart showing another example for manufacturing chitosan in the plant growth mediator having chitosan and chlorophyll generating accelerator of the present invention;

FIG. 5 shows the structure of one granular particle in water-soluble chitosan in the plant growth mediator having chitosan and chlorophyll generating accelerator of the present invention; and

FIG. 6 shows the structure of another granular particle in water-soluble chitosan in the plant growth mediator having chitosan and chlorophyll generating accelerator of the present invention.

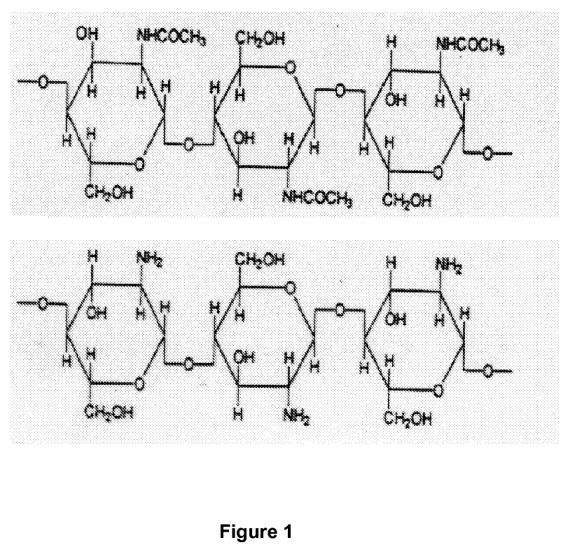

### PREFERRED EMBODIMENTS OF THE PRESENT INVENTION

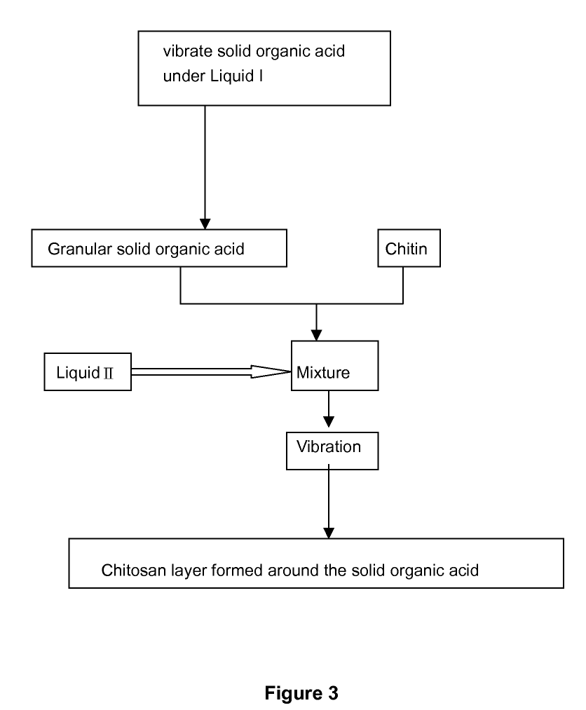

Please refer to FIG. 3. FIG. 3 is the method for manufacturing plant growth mediator having chitosan and chlorophyll generating accelerator. It comprises: (1) the process of vibration the solid organic acid for forming grains under the existence of liquid I; and (2) the process of vibration the mixture of chitin and the granular solid organic acid under the existence of liquid II.

The chitin mentioned above is insoluble in water, however, the plant growth mediator having chitosan and chlorophyll generating accelerator obtaining by the present invention can be dissolved in the water.

Chitosan generally can be dissolved in the organic and inorganic acid with acid or dilute acid, such as, acetic acid, formic acid, lactic acid, citric acid, pyruvic acid, hydrochloric acid, sulfuric acid, and phosphoric acid etc., wherein formic acid is the best dissolvent which can dissolve over 50% of chitosan.

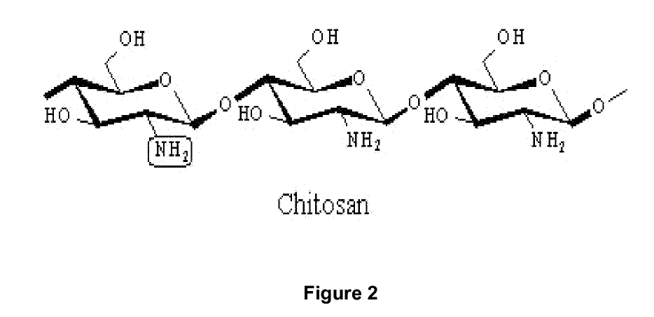

FIG. 2 shows a structure formula of the polymer water-soluble chitosan. In the excellent preservative and stable properties, the granular water-soluble chitosan is preserved in a solid state by adhering around the organic acid in drinking water. It has a better stable preservation than the one in a liquid state. In other words, the granular chitosan in the plant growth mediator having chitosan and chlorophyll generating accelerator of the present invention does not cause any problem which is happened in chitin in a liquid state. For example, the color becomes brown, and the liquid becomes turbid and causes a solid crystal form. The plant growth mediator having chitosan and chlorophyll generating accelerator of present invention then shall not change it qualities, it provides excellent effect of absorption to plants when it is applied.

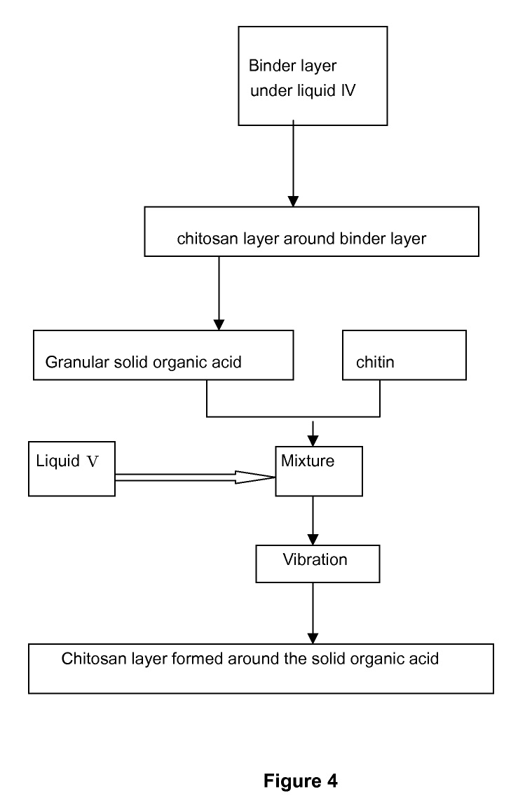

Please refer to FIG. 4. FIG. 4 is another preferred embodiment of the present invention showing a method for manufacturing water soluble chitosan of plant growth mediator having chitosan and chlorophyll generating accelerator of present invention. It comprises the steps of: (1) vibrating the solid organic acid forming grains under the existence of liquid III; (2) vibrating the mixture of a binder and above mentioned granular solid organic acid under the existence of liquid IV; and (3) vibrating the mixture of chitosan and above mentioned granular solid organic acid under the existence of liquid V.

The water-soluble chitosan with granular particles (hereinafter referred to as “2^{nd} water-soluble chitosan”) obtained by the above preferred embodiment includes a binder layer. Since this water-soluble chitosan with granular particles chitosan includes a binder layer, the 2^{nd} water-soluble chitosan has a higher solubility while compared to the 1^{st} water-soluble chitosan.

The solid organic acid (molecular weight of the organic acid is 2000˜100,000) used for manufacturing the plant growth mediator having chitosan and chlorophyll generating accelerator of the present invention is formed as crystal or powder for the best usage. Further, there is no specialized limitation for the type of the organic acid. For example, malic acid, citric acid, succinic acid, Malonic acid, maleic acid, and fumaric acid selected from polycarboxylic acid, and ascorbic acid all can be the organic acid for manufacturing the chitosan used in the drinking water of the present invention. And, the solid organic acid plays a core role in the water-soluble chitosan with granular particles. Further, the solid organic acid can be dissolved in the water as well as neutralize chitosan. It creates an environment for chitosan with an easier water-dissolution. In other words, the solid organic acid has a property for being neutralized or no PH state.

In order to make chitosan be dissolved completely, the best use quantity of the solid organic acid is higher than the quantity of glucosamine for neutralizing chitosan. Chitosan obtained by the method for manufacturing plant growth mediator having chitosan and chlorophyll generating accelerator of present invention is made from chitin (poly-β-1,4-N-acetyl-D-glucosamine) and concentrated alkali solution after heating and then processing deacetylation. Chitosan is a polymer composition mainly formed by poly-β-1 and 4-N-acetyl-D-glucosamine. There is no specialized limitation on the molecular weight of chitosan. In the present invention, water-insoluble chitosan can be simply dissolved in the water. More particularly, the water-insoluble chitosan at 2000˜100,000 of molecular weight has an obvious effect. In deacetylation degree, it is applicable when the deacetylation degree is over 60%. More, the best application in the present invention is the deacetylation degree over 80%. In the size of chitosan, there is also no specialized limitation. The best size is over 40 meshes.

There are many kinds of binders applicable in the method for manufacturing plant growth mediator having chitosan and chlorophyll generating accelerator of present invention. For example: oligosacchride, inositol, starch, dextrin, and dietary fiber ect. The above binders can be used individually or by mixture. General speaking, carbohydrate includes oligosacchride, inositol, and lactose. D-trehalose dehydrate, Isomaltase, D-raffinose, lactose are the products from oligosacchride. More, erythritol, and lactase are the products from inositol. Besides, fiber includes cellulose, hemi-cellulose, gums, pectin, and lignin. For example, wheat flour, bran, cabbage, yong peas, broccoli, and peppers belongs cellulose of fiber.

The binder layer for manufacturing the plant growth mediator having chitosan and chlorophyll generating accelerator of present invention is between the core of the organic acid and the chitosan layer. It has the following advantages:
1. When the water-soluble chitosan having granular particles is put into the water, chitosan will be swollen by the wet water. Later, the binder and the organic acid are dissolved in the water accordingly. Therefore, the water-soluble chitosan with the binder has a higher solubility.
2. The use quantity of the binder basically is various with the size of the grain. If the weight of the organic acid is 100, the use quantity of the binder is at 50˜100.

### EXAMPLE 1

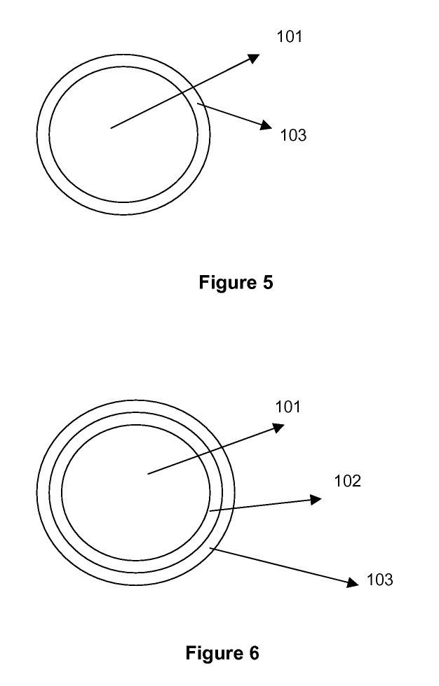

Please refer to FIG. 5, it is the first preferred embodiment of the structure of one granular particle of water-soluble chitosan in the plant growth mediator having chitosan and chlorophyll generating accelerator of present invention. The first preferred embodiment of a method for manufacturing water-soluble chitosan with granular particles. It comprises the steps of: under existence of liquid I, the solid organic acid being vibrated for forming grains.

After forming the mixture of the granular solid organic acid and chitin, liquid II is added. In the meanwhile, the mixture is vibrated until the chitosan layer 103 is formed around the solid organic acid 101.

### EXAMPLE 2

Please refer to FIG. 6. It is the second preferred embodiment of the structure of one granular particle of water-soluble chitosan in the plant growth mediator having chitosan and chlorophyll generating accelerator of present invention. The second preferred embodiment includes the water-soluble chitosan (hereinafter referred to as “2^{nd} water-soluble chitosan”) of granular particles.

The second preferred embodiment includes the granular water-soluble chitosan having the binder layer 102 around the solid organic acid 101. Further, the chitosan layer 103 is formed around the binder layer 102.

The method for manufacturing the 2^{nd} water-soluble chitosan comprises the steps of: 1. Under the structure of liquid II, vibrating the mixture of chitin and the granular solid organic acid formed in the first manufacture method;
2. Adding liquid IV into the mixture of the granular solid organic acid and the binder formed from Example 1. In the meanwhile, the mixture is vibrated until the binder layer is formed around the solid organic acid;
3. Later, adding liquid V into the mixture of the solid organic acid with the formed binder layer and chitosan. In the meanwhile, the mixture is vibrated for forming the chitosan layer around the binder layer. Therefore, the “2^{nd} water-soluble chitosan of granular particle” is obtained.

The vibration method as mentioned in the above is commonly used. For example, a rotary granulator can be used as an adequate vibration method while manufacturing a large amount of granular water-soluble chitosan.

Liquid I used for manufacturing the water-soluble chitosan having granular particle of examples can be water or alcohol. The water or alcohol can be used individually or by mixture. In the type of alcohol, the lower boiling point is best for this type. For example, ethyl alcohol is the best liquid to use among methyl alcohol, ethyl alcohol, and propyl alcohol. When mixing the water and alcohol, the best mixture ration (ethyl alcohol: water) is 80:20. In addition, liquid I is the necessary for forming grains from the solid organic acid. When the weight of the solid organic acid is 100, the best use quantity of liquid I is at 10˜20.

General speaking, the preferred embodiment of liquid II is same as the one of liquid I. Therefore, when mixing the water and alcohol, the mixture ration of liquid II (ethyl alcohol: water) mostly is same as the ration of liquid I. Liquid II is the necessary substance for chitosan to adhere around the solid organic acid. When the weight of the solid organic acid is 100, the best use quantity of liquid II is at 10˜20.

The preferred embodiment of liquid III is same as liquid I. The preferred embodiment of liquid IV is same as liquid II. When mixing the water and alcohol, the best mixture ration (ethyl alcohol: water) is 80:20.

Liquid IV is the necessary substance for the binder to adhere around the solid organic acid. When the weight of the solid organic acid is 100, the best use quantity of liquid IV is at 10˜20.

The preferred embodiment of liquid V is same as the one of liquid II. When mixing the water with alcohol, the best mixture ration (ethyl alcohol: water) is 80:20. Liquid V is the necessary substance for chitosan to adhere around the solid organic acid. When the weight of the solid organic acid is at 100, the best use quantity of liquid V is at 10˜20.

### EXAMPLE 3

One of the preferred embodiments for obtaining chitosan in the method of manufacturing plant growth mediator having chitosan and chlorophyll generating accelerator of the present invention is that, 8 mg of the crystalline malic acid is added into the synthetic resin bag. Then, 1 liter of water by a spray method is added with vibration for 3˜5 minutes. Later, 10 mg of powder chitosan (molecular weight is 50,000˜60,000, and deacetylation degree is 80˜90%) is added. In addition, 3 liters of water by a spray method is added with vibration for 3˜5 minutes as forming the water-soluble chitosan having granular particles. Lastly, the grain is taken away from the bag. By using a dryer at 35° C. of constant temperature for 30 minutes, the granular size of the granular water-soluble chitosan after drying is about 20˜30 mesh.

### Experiment I

In order to investigate the solubility of the granular water-soluble chitosan, the present invention processes the following experiment I.

First, 1 mg of the water-soluble chitosan having granular particles obtained from the above manufacturing process is stirred by the stirrer for 3˜5 minutes after adding 100 liters of warm water (35° C.). After stirring, insoluble residuum is filtered. After residuum is dried, the residual ration is measured and obtained. The above manufacture is repeatedly processed for 5 times, and the residual ration from the measurement is between 0.5% and 0.8%.

### EXAMPLE 4

Another preferred embodiment for obtaining chitosan in the method of manufacturing plant growth mediator having chitosan and chlorophyll generating accelerator of the present invention is that, 8 mg of the crystalline malic acid is added into the synthetic resin bag. Then, 1 liter of ethyl alcohol by a spray method is added with vibration for 3˜5 minutes. More, 5 mg of dextrin and 1 liter of ethyl alcohol by a spray method are added with vibration. Later, 10 mg of powder chitosan (molecular weight is 50,000˜60,000, and deacetylation degree is 80˜90%) is added. Furthermore, 6 liters of 80% of ethyl alcohol by a spray method is added with vibration for 3˜5 minutes as forming the granular water-soluble chitosan. Lastly, the grain is taken away from the bag. By using a dryer at 35° C. of constant temperature for 30 minutes, the granular size of the granular water-soluble chitosan after drying is about 20˜30 mesh.

### Experiment II

In order to investigate the solubility of the granular water-soluble Chitosan as obtained form the above manufacture, the present invention again processes the following experiment II.

A. Firstly, preparing plant growth mediator by the following process:

### Process 1:

Preparation of Liquid I: Add 100 g of Chitosan and 60 g of hydrochloric acid into 4640 g of water to obtain solvent.

### Process 2:

Preparation of Liquid II: Add 539 g of Calcium chloroide two hydrate (CaCl2. 2H₂O) into 4461 g of water to obtain solvent.

### Process 3:

Preparation of Liquid III: Add 120 g of lactic acid and 100 g of Chitosan into 4580 g of water to obtain solvent.

### Process 4:

Preparation of Liquid IV: Add 370 g of Ammonium molybdate 4 hydrates [(NH₄)₆Mo₇O₂₄.4H₂O] and 1100 g of lactic acid into 3530 g of water to obtain solvent.

### Process 5:

Preparation of Liquid V: Add 15.72 g of copper sulfate 5 hydrates (CuSO₄.5H₂O) 1706 g of zinc sulfate 7 hydrates (ZnSO₄.7H₂O) and 17.6 g of Mangnese sulfate 5 hydrates (MnSO4.5H2O) into 349.08 g of water to obtain solvent.

### Process 6:

Preparation of Liquid VI: Mix Liquid I with Liquid II.

### Process 7:

Preparation of Liquid VII: Mix Liquid III and Liquid IV.

### Process 8:

Preparation of Liquid VI: Mix Liquid VI and Liquid VII, and then add Liquid V, 20 Kg of plant growth mediator for this experiment is obtained.

The plant growth mediator manufactured by the above stated processes to contains the components shown in the following:

| Component | Ratio (Proper Range Of Ratio) |
|---|---|
| Molybdenum | 1 wt % (0.5-3.0 wt %) |
| Calcium | 0.5 wt % (0.1-2.0 wt %) |
| Copper | 0.02 wt % (0.01-0.05 wt %) |
| Zinc | 0.02 wt % (0.01-0.05 wt %) |
| Mangnese | 0.02 wt % (0.01-0.05 wt %) |
| Ammonium Ion | 0.16 wt % (0.1-0.5 wt %) |
| Chitosan (Molecular weight | 1 wt % (0.5-5.0 wt %) |
| 10,000-20,000) | |

This experiment investigates the growth conditions of spinaches after the prepared plant growth mediator is applied.

In order to understand the function of present invention, the growth conditions of spinaches without applying the plant growth mediator is also investigated (control area). In the experiment, the plant growth mediator obtained by the above preparation processes is diluted to 200 times of liquid for the application of plant's leaves. Before two weeks and one weeks of spinach cropping, the diluted plant growth mediator is spread onto the leaves of spinach by the quantity of 200 liter per 1 square meter. In the control area, the spinach and cabbage were planted as the same way of planting the spinach of the experiment, except without using the plant growth mediator of present invention. After planted, the investigation results of (1) content of chlorophyll; (2) content of nitric radical; (3) content of calcium; (4) content of sugar and (5) production quantity are shown as the following tables:
1. The content of chlorophyll are measured in two portions according to method known to public:
   A. The core of stem, middle Leaves and upper leaves

TABLE 1

| | Experimental Area | | | Control Area | | |
|---|---|---|---|---|---|---|
| | | | Upper | Stem | Middle | Upper |
| | Stem Core | Middle Core | Core | Core | Core | Core |
| Measured | 47.2 | 53.6 | 52.1 | 41.5 | 49.6 | 51.0 |
| Value | | | | | | |
| Ratio | 114 | 108 | 102 | 100 | 100 | 100 |

B. The chlorophyll of the oldest leave

TABLE 2

| | Experimental Area | Control Area |
|---|---|---|
| Measured Value | 64.2 | 52.2 |
| Ratio | 123 | 100 |

2. The content of nitric radicals in spinaches are measured and obtained by using the method known to public (the average value of three measured values.)

TABLE 3

| | Experimental Area | Control Area |
|---|---|---|
| Measured Value(ppm) | 1833 | 3407 |
| Ratio | 53 | 100 |

3. The average value of the content of calcium in juice of three cabbage are as follows:
   A. The old leaves

TABLE 4

| | Experimental Area | Control Area |
|---|---|---|
| Measured Value(ppm) | 43.5 | 23.3 |
| Ratio | 186 | 100 |

B. The new bud

TABLE 5

| | Experimental Area | Control Area |
|---|---|---|
| Measured Value(ppm) | 15.0 | 6.5 |
| Ratio | 230 | 100 |

Statement: It is known to public that the calcium would gather in the old leaves, however, according to the results of table 4 and table 5, the plant growth mediator of present invention can make the new buds contain large quantity of calcium.
4. Measure the sugar content of cabbage by the method known to public, the results is shown in Table 6.

TABLE 6

| | Experimental Area | Control Area |
|---|---|---|
| Measured Value(ppm) | 8.8 | 4.6 |
| Ratio | 191 | 100 |

5. The production quantity of cabbage is measured as follows (The average value of producing 20 cabbages).

TABLE 7

| | Experimental Area | Control Area |
|---|---|---|
| Measured Value(kg) | 2.7 | 1.7 |
| Ratio | 1.59 | 1 |

Conclusion: From Table 1 to Table 7, it can be clearly to see that (1) the content of chlorophyll, (2) the content of nitric radical, (3) the content of calcium, (4) the content of sugar, and (5) the production quantity of the vegetables produced in the experimental area is much better then these produced in the control area.

### EXAMPLE 5

Add the plant growth mediator having chlorophyll generating accelerator into chitosan obtained from the above examples, then the solvents becomes the plant growth mediator having chitosan and chlorophyll generating accelerator of present invention.

The accelerators and catalysts of generating chlorophyll are mentioned above, it is generally used as the chemicals of“oxalates”, “sulfates” or “acetates”. Wherein, the examples of irons can be “ferric sulfates”, “ferric oxalates” or “ferric acetates”; the examples of zinc can be “zinc sulfates”, “zinc acetates”, “zinc lactates”; the examples of Manganese(Mn) can be “manganese sulfates”, “manganese acetates” etc.

The molecular weights of chitosan is between 200,000-2000,000, the chitosan to be used in the present invention is preferably having 100,000-500,000 of molecular weight. The chlorophyll generating accelerator mixed with chitosan having molecular in the range shown above can twicely increasing the dissolubility of chlorophyll generating accelerator. That is to say, chitosan can twicely speedy the absorption of a plant to chlorophyll generating accelerators.

The plant growth mediator of present invention can be obtained by mixing at least one chlorophyll generating accelerator or with chitosan, In the plant growth mediator of present invention, the ratio of chlorophyll generating accelerator to the whole plant growth mediator is 0.005-1.5 wt %, preferably, 0.01-0.05 wt %; the ratio of chitosan to chlorophyll generating accelerator is 0.5-5 wt %, preferably 1-3 wt %.

Due to the existence of chitosan, the chlorophyll generating accelerator of the above mentioned plant growth mediator can be easily absorbed by the leaves of plants. Then it is also applied as diffusion agent of plant's leaves. In addition, the plant growth accelerator can add with plant growth mediator having calcium or/and molybdenum, wherein, calcium can be 0.1-2 wt % of the plant growth mediator, which molybdenum can be 0.5-3 wt % of the plant growth mediator.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. For example, it should be obvious that the slider guide may be formed as a monolithic piece or may be an assembly having two or more parts. Therefore it is intended that the invention not be limited to the particular embodiment disclosed as the best mode contemplated for carrying out this invention, but that the invention will include all embodiments falling within the scope of the appended claims.

What is claimed is:

1. A method for manufacturing a plant growth mediator having chitosan and a chlorophyll generating accelerator having chitosan, comprising the steps of:
under existence of a liquid I, vibrating a solid organic acid for forming granular particles;
under existence of a liquid II, vibrating a mixture of chitin and a granular solid organic acid, and
adding the mixture into at least one chlorophyll generating accelerator and/or catalyst thereof.

2. The method as claimed in claim 1, wherein a quantity of the solid organic acid is higher than that of glucosamine for neutralizing chitosan.

3. The method as claimed in claim 1, wherein the solid organic acid is polycarboxylic acid, or ascorbic acid.

4. The method as claimed in claim 1, wherein the liquid I or the liquid II is formed by at least one selected from water or alcohol.

5. A method for manufacturing a plant growth mediator having chitosan and a chlorophyll generating accelerator having chitosan, comprising the steps of:
(a) under existence of a liquid III, vibrating a solid organic acid for forming granular particles;
(b) under existence of a liquid IV, vibrating a mixture of a binder and the granular solid organic acid;
(c) under existence of a liquid V, vibrating a mixture of chitosan and the granular solid organic acid; and
(d) adding substances obtained in step (c) into at least one chlorophyll generator accelerator and/or catalyst thereof.

6. The method as claimed in claim 5, wherein a quantity of the solid organic acid is higher than that of glucosamine for neutralizing chitosan.

7. The method as claimed in claim 5, wherein the solid organic acid is polycarboxylic acid, or ascorbic acid.

8. The method as claimed in claim 5, wherein the liquid III, the liquid IV or the liquid V is formed by at least one selected from water or alcohol.

9. The method as claimed in claim 5, wherein the binder is formed by at least one selected from starch, carbohydrate, or oligosaccharide.

10. The method as claimed in claim 1, wherein a granular water-soluble chitosan is formed around the solid organic acid.

11. The method as claimed in claim 5, wherein a granular water-soluble chitosan is formed around the solid organic acid.

12. The method as claimed in claim 1, wherein the chlorophyll generating accelerator and the catalyst are sulfates, oxalates, acetates or lactates of iron, calcium, phosphine, magnesium, manganese or zinc.

13. The method as claimed in claim 5, wherein the chlorophyll generating accelerator and the catalyst are sulfates, oxalates, acetates or lactates of iron, calcium, phosphine, magnesium, manganese or zinc.

14. The method as claimed in claim 1, wherein a molecular weight of applied chitosan is between 100,000 to 500,000.

15. The method as claimed in claim 5, wherein a molecular weight of applied chitosan is between 100,000 to 500,000.

16. The method as claimed in claim 12, wherein a ratio of chlorophyll generating accelerator is 0.005 to 1.5 wt % of plants growth mediator.

17. The method as claimed in claim 13, wherein a ratio of chlorophyll generating accelerator is 0.005 to 1.5 wt % of plants growth mediator.

18. The method as claimed in claim 12, wherein a ratio of chitosan to chlorophyll generating accelerator is 0.5 to 5 wt %.

19. The method as claimed in claim 13, wherein a ratio of chitosan to chlorophyll generating accelerator is 0.5 to 5 wt %.
